(19) United States
(12) Patent Application Publication
(10) Pub. No.: US 2008/0196136 A1
(43) Pub. Date: Aug. 21, 2008

(54) Laminated Fabric Panels and Method of Assembling Same

(75) Inventors: Catherine Fellouhe, Vieugy (FR); Eddy Fellouhe, Seynod (FR); Isabelle Roux, Metz-Tessy (FR); Serge Chapuis, Lepin le Lac (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 11/572,771

(22) PCT Filed: Jul. 28, 2005
(86) PCT No.: PCT/FR2005/001971

§ 371 Date: Feb. 14, 2008

(30) Foreign Application Priority Data
Jul. 29, 2004 (FR) 0408405
Jul. 26, 2005 (FR) 0508010

(51) Int. Cl. A41D 1/00; A41D 27/00; B32B 3/00; B32B 3/06

(52) U.S. Cl. 2/69; 2/243.1; 428/57; 428/102

(57) ABSTRACT

Laminated fabric panels and a method of assembling such panels. A garment, for example, is made of first and second parts assembled to one another by superimposing the first part and the second part so that their inner surfaces face one another; welding the two parts along a weld line; flattening the two parts, the weld line being arranged on the outer side; applying a reinforcement strip to the welding line on the outer side of the garment.

### BACKGROUND OF THE INVENTION

1. Field of the Invention

The invention relates to a method of assembling fabric panels and to the products assembled by such method.

More particularly, the invention relates to the field of clothing or garments and/or bags.

It particularly relates to the field of sports garments and/or clothing to be in direct contact with the skin, such as underwear, swimsuits, and articles of lingerie, the invention providing more comfort for such type of clothing.

The invention also relates to the field of sports garments, sports bags and/or waterproof and/or water-resistant garments.

2. Description of Background and Relevant Information

In terms of lingerie, garments are generally assembled by means of extensible seams, of the overhand stitch or French seam type, but these seams are not very flat and can therefore cause discomfort.

Generally speaking, the closer to the body the garment is intended to be when worn, and the more the garment tends to move relative to the body during use, such as when the wearer is engaged in a sport, for example, the more likely attempts will be made to avoid friction between the body and the garment assembly seams and, therefore, the more likely attempts will be made to limit the thickness of such seams.

Furthermore, it is well known in the garment industry to use materials having a waterproof coating or laminates in order to produce waterproof garments.

The coating can be either external (for example, an oilskin coat), or the coating can be applied onto the inner surface of the garment; which is generally a PU or PVC coating.

Laminates are composite materials uniting several layers adhered together, one of them being generally made of a waterproof and/or breathable-waterproof and/or windproof membrane. These membranes can be made of PTFE, PU, etc.

Typical examples of such laminates are those provided with a so-called “breathable-waterproof” membrane, which is waterproof but permeable to water vapor, and such laminates are sold under the tradename Gore-Tex® or Sympatex®. These laminates can be made of two or three layers, depending upon whether the laminate must be integrated into the garment with other layers, or used as is, as in the case of a three-layered laminate, usually referred to as the “three-ply,” the membrane being inserted between an inner liner fabric and an outer shell fabric.

In the context of this description, the term “laminated material” refers to both (interiorly or exteriorly) coated fabrics and laminated fabric materials provided with a film or membrane acting as a windproof, waterproof, or water-resistant (or the like) barrier. Any membrane or coating, which acts at least as a barrier to water or any other liquid penetration, will also be referred to as a “protection layer,” a “functional layer,” a “membrane,” a “treatment,” or a “coating”.

Garments are generally made of pieces or panels of these laminates, the latter being assembled by means of stitched seams.

For garments which must be waterproof when finished, the seams must then be made waterproof, generally by applying a sealing strip provided with a thermoplastic or thermofusible adhesive.

For practical and aesthetic reasons, the seams are generally sealed inside the garment.

Gluing the sealing strips can however pose problems, depending particularly upon the material constituting the first layer of the laminate (or liner layer), especially for three-layered laminates, such as mentioned above.

Thus, the document US 2005/0081281 explains that, depending upon the type of liner layer, gluing can be insufficient for properly waterproofing the seam, and that, in order to overcome this problem, the liners are generally made of simple jerseys having a mono-filament type of open structure, which reduces the choice of materials that are available for such liners. Low-viscosity or liquid glues have also been developed to overcome this problem and enable the glues to penetrate inside more complex structures (see, e.g., the documents U.S. Pat. No. 6,387,994 and WO 01/26495).

The problem with gluing also arises in relation to water repellent and/or stain-repellent materials, which is especially the case with materials having a coating known by the tradenames Scotchguard®, or Teflon®, namely, a coating based on fluorine, Teflon, or the like. Repellent treatments of this type are also called durable water repellents or “DWR”. Hereinafter, the term “repellent treatment” will refer to any water-repellent and/or stain-repellent and/or DWR treatment.

To overcome these drawbacks, the aforementioned document US 2005/0022920 proposes removing or making even (by planing, grinding down, abrasion, cutting etc.) a portion of the liner fabric over at least a portion of the stitching zone to be made waterproof, the sealing strip being then applied over this entire zone.

It can be very complicated and difficult to carry out such a sizing or even-planing operation, as one must indeed not damage the membrane located beneath the evened-up layer. Furthermore, it is necessary to remove enough fabric to achieve the desired goal. In addition, the thickness of the fabric layers can vary more or less substantially, especially in the case of a fleece type of material; it can therefore be very difficult and complicated to adjust the sizing machine.

### SUMMARY OF THE INVENTION

The invention provides a new design for the assembly seams in a garment that can be used in direct contact with the skin.

The invention also provides for the assembly of an article of clothing that further minimizes friction or abrasion while using a garment that is worn in direct contact with the skin.

The invention further provides for the assembly of fabric materials allowing new aesthetics.

The invention additionally provides for the assembly and waterproofing of the seams of a garment or an article made of laminated fabric material.

In these regards, a method for assembling fabric panels according to the invention, which is fabric panels are of the type comprising at least a first panel and a second panel to be assembled to one another, comprises:
superimposing the first and the second panels so that their inner surfaces face one another;
welding the two parts along a predetermined welding line;
flattening the two panels, the welding line being arranged on the outer side;
applying a strip for reinforcing the welding line on the outer side of the article.

With this assembly method, all the parts that project from the welding line, or assembly “seam”, are outside of the article; and when the article is a garment, they do not cause any friction with respect to the body, even when the latter is moving.

This results in an incomparable comfort since there is no more “seam” or welding inside the garment, and therefore no more risk of friction with such a “seam”, even in the case where the garment is very tight and/or close to the body.

Furthermore, covering the welding line with a strip not only allows reinforcing said welding, but also giving it a very particular aesthetics.

According to an embodiment, the method comprises the step of cutting the excess matter beyond the welding line before the flattening, so that the welding line “showing” on the outer side has a minimal thickness that is not visible underneath the reinforcement strip.

The article then appears to be assembled only by means of the reinforcement strips.

According to another embodiment, the assembly method is applied to laminated fabric panels and includes the following steps:
providing at least two laminated panels, each laminated panel comprising at least one water-resistant protective layer fixed to the fabric material;
assembling the two panels along a predetermined joining line;
flattening the two laminated panels;
pre-positioning a sealing strip provided with an adhesive on the joining line by means of gluing;
subjecting the joining line to a temperature θ1 greater than the adhesive melting temperature, under a predetermined pressure P, for a predetermined duration T, so that at least a portion of the adhesive creeps into the interstices between the fabric fibers;
subjecting the joining line, at the end of the duration T, to an accelerated cooling by cold pressing, so as to congeal the adhesive.

Such a method ensures that the adhesive creeps completely in into the interstices between the fabric fibers, and thus wets the fibers, even though the fabric has been treated, and therefore guarantees the desired waterproofness; as well as guarantees, by means of accelerated cooling, that the adhesive does not shrink or separate, thus ensuring waterproofness or water-repellency of the finished product. Such a method achieves a very advantageous aesthetic effect while being compatible with coated fabric materials.

### BRIEF DESCRIPTION OF THE DRAWINGS

The invention will be better understood and other characteristics will become apparent from the following description, with reference to the attached schematic drawings, and in which:

FIG. 1 is a schematic view of an ultrasonic welding machine;

FIG. 2 is a schematic view of the first phase of the assembly method, according to a first embodiment of the invention;

FIG. 3 is a schematic view of the second phase of the assembly method, according to a first embodiment of the invention;

FIG. 4 is a schematic view of the third phase of the assembly method, according to a first embodiment of the invention;

FIG. 5 is a top view of a garment assembled by means of the method according to the first embodiment of the invention;

FIG. 6 is a schematic view of a first phase of the assembly method, according to a second embodiment of the invention;

FIG. 7 is a schematic view of a second phase of the assembly method, according to a second embodiment of the invention;

FIG. 8 is a schematic view of a third phase of the assembly method, according to a second embodiment of the invention;

FIG. 9 is a schematic view of the first step for applying the sealing strip, according to a second embodiment of the invention;

FIG. 10 is a schematic view of the sealing strip's adhesive material creeping step, according to a second embodiment of the invention;

FIG. 11 is a schematic view of the adhesive strip cooling step, according to a second embodiment of the invention;

FIG. 12 is a view of a garment assembled according to the method of the invention, according to a second embodiment of the invention.

### DETAILED DESCRIPTION OF THE INVENTION

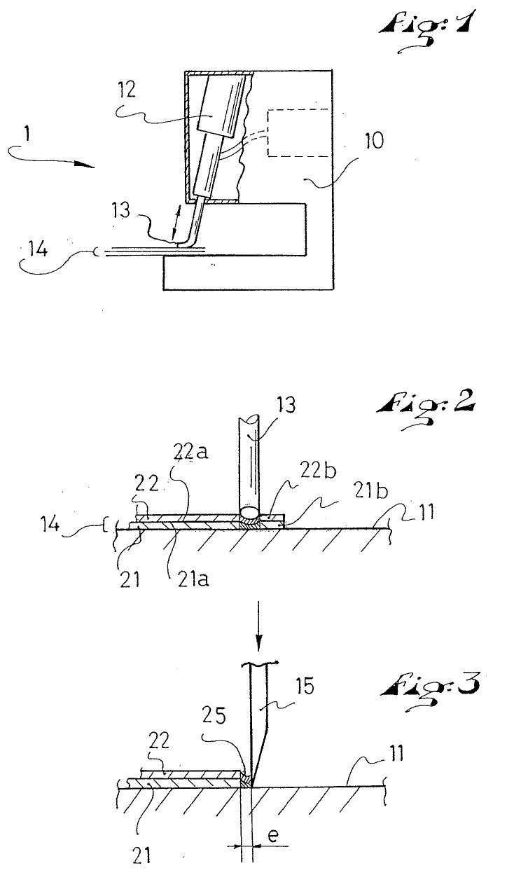

FIGS. 1 to 4 show various phases of an assembly method according to a first embodiment of the invention by means of an ultrasonic welding machine 1.

Such a machine is well known, for example from the document U.S. Pat. No. 3,817,802 and, therefore, is not described in detail herein. It comprises a stand 10 supporting the ultrasonic motor or vibrator 12, a plate 11 for supporting the elements 14 to be welded, and a welding tool 13.

There are also other ultrasonic welding machines in which the elements to be welded move forward between two rotary welding tools, under a pressure on the order of several bars, which allows an assembly like that of a sewing machine.

Based on the principle of ultrasonic welding, vibrations at a frequency ranging from 20 to 30 KHz are applied to the welding tool via the vibrator. The vibrations heat up the two layers of material to be assembled and causes them to weld to one another.

Other welding modes can be envisioned within the scope of the invention, particularly hot welding or high frequency welding.

A first panel 21 and a second panel 22 of the article of clothing to be assembled are superimposed on the support plate 11 so that their inner surfaces 21a and 22a, respectively, face one another, that is, are in contact with one another.

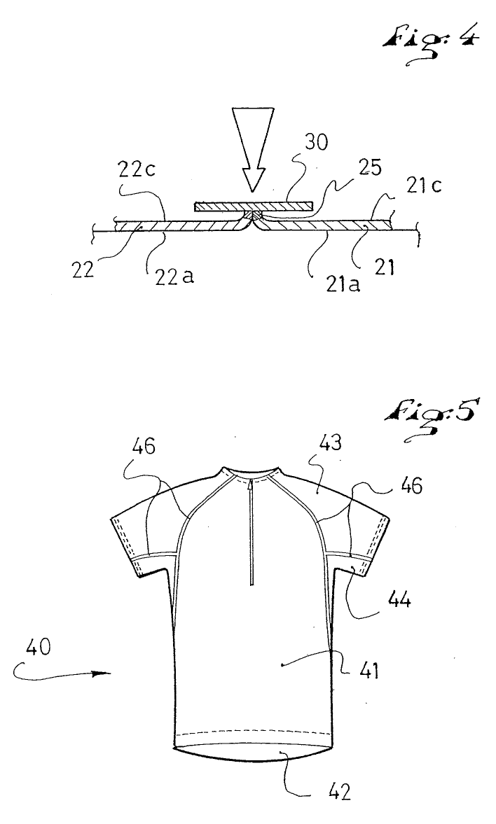

These two panels 21 and 22 are then welded to one another by means of the welding tool 13, as shown in FIG. 2, along a welding line 25. The excess material 22b, 21b located on the other side of the welding line 25, is removed almost simultaneously with the welding operation, by means of a tool 15 in the form of an adequate knife, as shown in FIG. 3, so that only the welding line 25 is left visible on the edge of the panels 21, 22. The welding line 25 then has a maximum thickness e of about 1 mm.

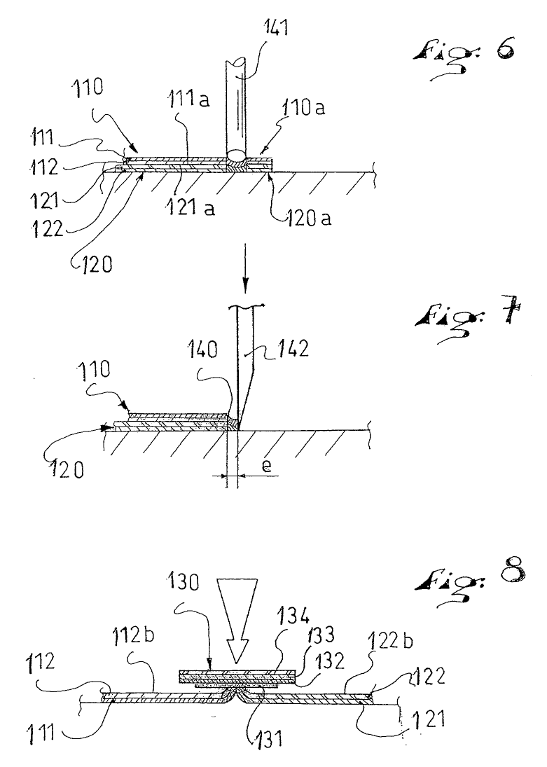

After cooling for a period of about ten seconds, the two panels 21, 22, which are welded together, are laid flat so that their outer surfaces 21c, 22c, respectively, are turned upward, as shown in FIG. 4. A reinforcement strip 30 is then applied by gluing on the visible portion of the welding line 25. The reinforcement strip 30 can in fact be a complexed strip constituted of a fabric support (extensible or not extensible) complexed with a layer of thermofusible glue of the polyurethane type. It can be a heat-adhesive strip such as known under the tradename Bernise® or Ardmel®. The thermofusing is generally done between 150 and 220° C. under a 1 to 5 bar pressure.

Due to the small thickness e of the welding line, the assembly, once completed, only allows the reinforcement strip 30 to be visible, whereas the inside of the garment is completely smooth and therefore causes no friction against the user's skin.

The materials used for the panels 21, 22 of the garment and for the reinforcement strip will be adequate with the welding/gluing mode that is used.

The panels 21, 22, can, for example, be mesh, or synthetic mesh, in particular made of polyamide or polyester.

The panels 21, 22 can also be made of an extensible material such as a mixture of polyamide and elasthane (tradename Lycra Power®). For a material made of 78% polyamide and 22% elasthane, for example, the elongation can be 218% lengthwise and 126% widthwise. For another example of material made of 92.8% polyamide and 7.2% elasthane, the elongation is only 62% lengthwise and 102% widthwise. Indeed, the ultrasonic welding is relatively extensible and can be used with extensible materials.

In any cases, the reinforcement strip 30 is selected so as to be also extensible, but with an elongation rate that is lower than that of the weld and panels 21, 22 in order to not risk damaging the ultrasonic weld. If none of the materials of the panels 21, 22 is extensible, the reinforcement strip 30 can also be non-extensible.

FIG. 5 shows a garment 40, of the tee-shirt type, assembled according to the invention.

In this case, the various panels of the tee-shirt, namely, the front 41, the back 42, the sleeves 43, and under the sleeves, at locations 44, are assembled by welding and applying reinforcement strips 46. Depending upon the materials used for the various panels 41, 42, 43, 44, the reinforcement strips 46 can be different.

Also within the scope of the invention are other applications thereof, in which only those panels of the garment which are most subjected to forces while worn, such as, for example, the areas of the knees for pants or tights, are made of extensible material, such as known under the tradename Lycra® or Lycra®Power, and are assembled according to the invention.

The invention can also be applied to the manufacture of fabric articles other than garments, in particular bags, or the like, the aesthetical effect achieved by means of the method according to the invention being particularly advantageous.

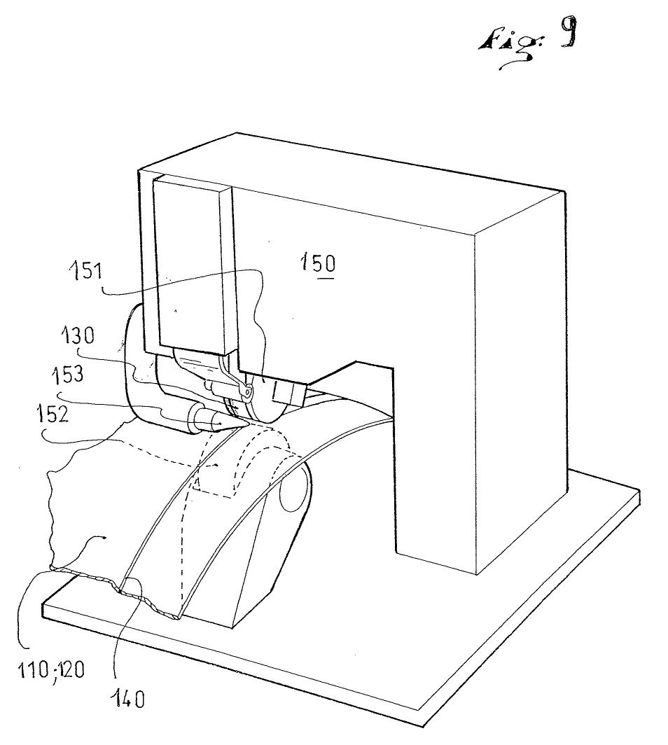

FIGS. 6 to 12 illustrate various phases of a method according to a second embodiment of the invention, as applied to the assembly of two laminated panels 110, 120.

Each laminated panel 110, 120 is made of at least two layers 111, 112, and 121, 122, respectively.

According to a first example, the laminated panels 110, 120 are water-repellent-treated fabric panels (DWR), meaning that they are covered with a fluorine-based coating or a Teflon-based coating, or the like, each layer 111, 121, therefore, being a fabric layer, either woven, or plain knitting, made from a synthetic material such as PA, PE, polypropylene, with or without elastic fibers such as known by the tradename Lycra®, etc.

It can also be a fabric provided with a breathable-waterproof membrane (PTFE, PU) known as “three ply”, three layers, described above.

Each layer 112, 122 shows the water-repellent treatment which, for example, can be of the type known by one of the tradenames Scotchguard®, Teflon®, or the like.

Other water-repellent and/or water-resistant treatments can also be provided. In the case described, the water-repellent treatment is applied over the outer surface of the fabric. It could also be applied over the inner surface.

In a first step of the assembly method according to the invention, the two panels 110, 120 are superimposed so that their inner surfaces 111a, 121a face one another, that is, they are in contact with one another, as shown in FIG. 6.

The two panels 110, 120 are then welded to one another by means of an ultrasonic welding machine (not shown in FIG. 6), by means of a welding tool 141 along a joining line 140.

Ultrasonic welding machines are well known, for example, from the document U.S. Pat. No. 3,817,802, as mentioned above, and, therefore, the machine used is not described in detail here.

Based on the principle of ultrasonic welding, vibrations at a frequency ranging from 20 to 30 KHz are applied to the welding tool. The vibrations heat up the two layers of material in contact with one another and cause them to weld to one another by melting.

Other welding modes are encompassed within the scope of the invention, particularly hot welding or high frequency welding.

A more conventional type of assembly, such as stitching, for example, is also encompassed within the scope of the invention.

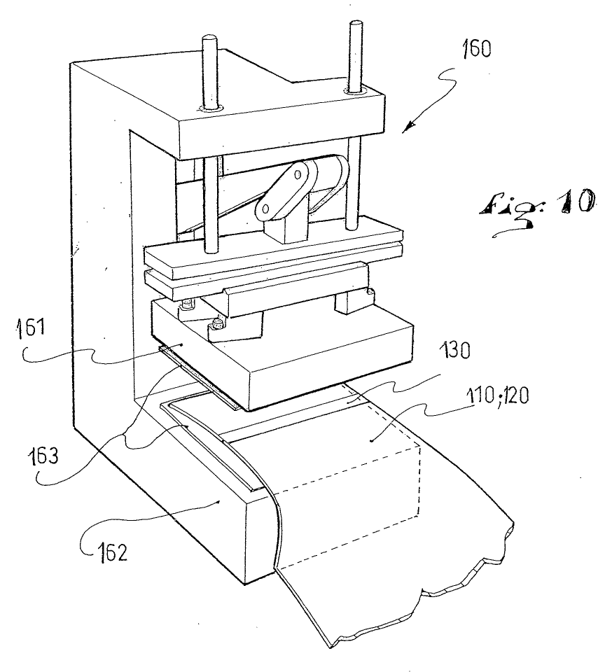

The excess material 110a, 120a located on the other side of the joining line 140 is removed, almost simultaneously with the welding operation, by means of a tool 142 in the form of an adequate knife, as shown in FIG. 7, so that only the weld or joining line 140 is left visible on the edge of the panels 110, 120.

The weld or joining line 140 then has a maximum thickness e of about 1 mm.

This principle of removing the excess material 110a, 120a can also be applied to the other assembly modes, for example stitching, that is also within the scope of the invention.

After cooling by air, or after cooling by another method, for a period of about ten seconds, the two panels 110, 120, which are welded together, are laid flat so that their outer surfaces 111b, 122b, respectively, are turned upward. A sealing and reinforcement strip 130 is then applied by gluing on the visible portion of the joining line 140, as shown in FIG. 8.

In the example shown (see FIG. 8), the sealing strip 130 is made of 4 layers, namely:
a first layer 131 of sealing glue, such as sold under the tradename Ardmel® TO41. This glue is extremely fluid and heat-meltable so as to completely fill the interstices between the fibers constituting the fabrics 111, 121 and to ensure waterproofness. This glue is “sticky” to the touch when cold.
a second layer 132 of thermofusible polymer material having great mechanical strength and especially a great tensile strength, as well as a great resistance to washes and hydrolysis.
a third layer 133, which is a coating layer or a membrane with a PU, PE, polyamide basis, or the like, and which is adapted to prevent the layer 132, that is, the layer of glue, from creeping outward, that is, toward the fourth layer.
a fourth layer 134, which is a layer of fabric material, or the like, adapted to provide a longitudinal and transverse mechanical strength and a decorative effect. This fourth layer can be coated with a color or raised imprint to provide a decorative effect.

The two layers of glue 131, 132 can be combined into a single layer.

According to an embodiment of the invention, this layer 134 is made of the same laminated material as that of the panels 110, 120. In this case, it is also provided with the same treatment or outer coating. If the base layer 111, 121 is a laminate, that is, a complex with a membrane, only the outer layer of this laminate, that is, the one without a breathable-waterproof membrane, but with or without a water-repellent treatment, will be used to form the layer 134 so as to limit the thicknesses.

This layer 134 can be in the same color, or in a different color so as to be in contrast with that or those of the panels 110, 120.

In the example described, the third layer 133 is used to prevent the glue from creeping toward the outer decorative layer 134 during the various parts of the method. Also encompassed by the invention is a sealing strip having only the two first layers 131, 132, and therefore lacking a decorative layer. In this case, the third layer is not necessary, but the layer of glue 132 is provided with a mesh, or the like, embedded therein, which gives it the necessary mechanical strength and finish.

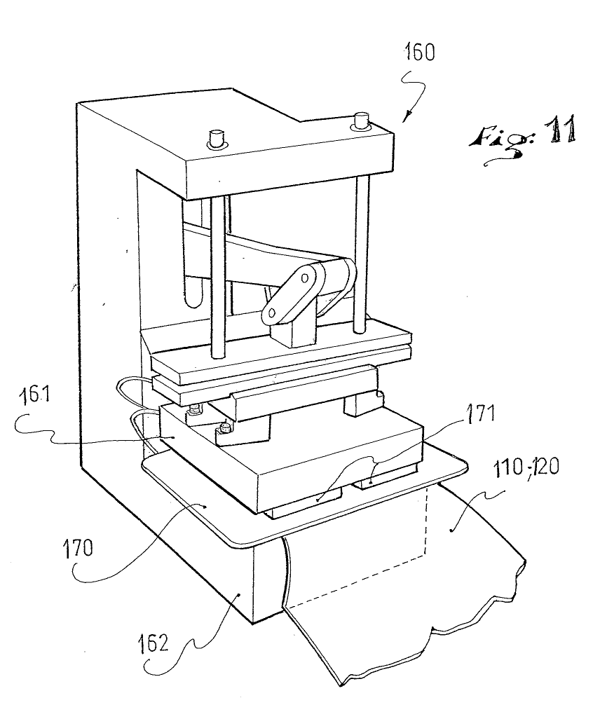

The sealing strip 130 is glued according to three separate phases of the method shown in FIGS. 9 to 1.

In a first phase, shown in FIG. 9, the strip 130 is applied by means of a press 150 or machine for applying sealing strips such as the known type sold under the tradenames Pfaff® or Ardmel®, provided with rollers 151, 152 driving the assembled sealing strip 130 and the laminated panels 110, 120, the adhesive material of the strip 130 being softened beforehand by hot air coming from a nozzle 153.

The temperature of the hot air coming from the nozzle is 130° C. or approximately 130° C., and the assembly pressure is 5 bars or approximately 5 bars. The temperature and the pressure for assembling can be different depending upon the fabrics to be assembled and the sealing strip used.

Such an operation allows an assembly of the strip 130, such as described in the first embodiment, that is satisfactory for holding the strip and the joining line 140, even if the assembly is done by welding, but that is insufficient to ensure waterproofness of said assembly, and therefore of the garment and/or bag in its entirety.

The actual waterproof assembly is carried out by means of two following phases.

In the second phase, shown in FIG. 10, the two assembled panels provided with the sealing strip 130 are hot-pressed between the two flat beds 161, 162 of a press. The movable upper flat bed 161 is heated and brought to a temperature between 130 and 150° C., which depends on the type of polymer constituting the first layer 131 of the sealing strip, and on the type of fabrics to be assembled. Sheets of silicon-coated paper 163 can be superimposed between each heating flat bed and the panels 110, 120 to prevent the glue from creeping on these flat beds. According to the embodiment described, this temperature is on the order of 150° C., the pressure is 2 bars, and the duration of the application is approximately 25 seconds. This hot-pressing phase ensures a proper creeping of the layer 131 until penetrates into all of the interstices between the fibers.

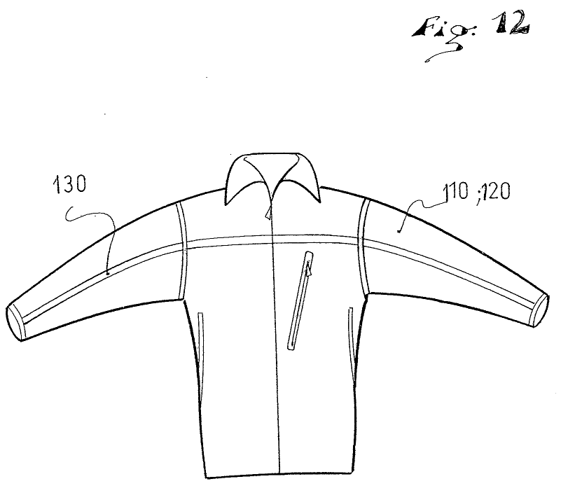

At the end of this hot-pressing phase, the upper flat bed 161 is raised, and lowered again after the insertion of a cold metal plate 170, shown in FIG. 11, provided with insulating blocks 171 to prevent any transmission of heat from the upper flat bed to the cold plate.

The cold plate 170 can simply be at room-temperature or can be cooled off to a temperature ranging from 0 to 10° C., depending upon the type of glue.

The cold plate 170 is kept under a 2-bar pressure for 5 to 10 seconds, for example. The press can also be one that includes two pivoting flat beds for hot-pressing or cold-pressing.

During this last phase, a cold-pressing is undertaken, which prevents any shrinking of the first gluing layer 31 and therefore ensures an adequate distribution of the glue inside interstices of the fabric, and therefore waterproofness.

This phase is therefore particularly important for the waterproofness of the final assembly.

The assembly and waterproofing method described hereinabove makes it possible to obtain an assembly that is waterproof at 2 m (200 mm) or 200 mbar with a rise in pressure of 60 mb/mm according to the ISO 811 standard-compliant method of dynamic testing and according to the AATCC 127 standard-compliant method of dynamic testing. FIG. 12 shows an example of garment made by the invention, in this case a long-sleeved tee-shirt, including laminated panels 110, 120 assembled according to the method, their assembly lines being covered by sealing strips 130.

The invention is not limited to the several embodiments described hereinabove, but also applies to bags made from supple and flexible materials and to waterproof and/or water resistant fabrics, whether they are laminated as those described, or not laminated.

The invention also applies to any type of assembly of products made from fabric materials having a waterproof and/or water-resistant coating.

In the case of the second embodiment described, the laminated panels can be extensible as in the first embodiment described, and in this case, the sealing strip 130 can have an elongation rate lower than that of the joining line 140, particularly when the latter is made by welding.

1-25. (canceled)

26. A method of assembling fabric panels of a garment, said method comprising:
assembling a first panel to a second panel by superimposing said first panel to said second panel, whereby respective inner surfaces of said first and second panels face one another and respective outer surfaces of said first and second panels face away from one another;
welding said superimposed first and second panels along a predetermined line, thereby creating a weld line;
opening said superimposed first and second panels so that said inner surfaces are spread apart, not facing one another, said first and second panels being connected at said weld line;
applying a reinforcement strip upon the weld line and on said outer surfaces of said first and second panels when said first and second panels are opened and spread apart.

27. A method according to claim 26, wherein:
said opening said superimposed first and second panels comprises flattening said first and second panels.

28. A method according to claim 26, further comprising:
before opening said superimposed first and second panels, cutting excess material beyond the weld line.

29. A method according to claim 26, wherein:
the weld line has a thickness of about 1 mm.

30. A method according to claim 26, wherein:
said welding is performed by an ultrasonic welding machine.

31. A method according to claim 26, wherein:
the reinforcement strip has an elongation rate lower than an elongation rate of the weld line.

32. A textile article comprising:
a first panel having an inner side and an outer side;
a second panel having an inner side and an outer side;
said first and second panels being assembled together along a weld line, said weld line being on said outer sides of said first and second panels;
a reinforcing strip covering said weld line.

33. A textile article according to claim 32, wherein:
said weld line has a thickness of about 1 mm or less.

34. A textile article according to claim 32, wherein:
each of said first and second panels is made of elastic material.

35. A textile article according to claim 32, wherein:
said reinforcement strip has an elongation rate lower than an elongation rate of said weld line.

36. A textile article according to claim 32, wherein:
each of said first and second panels comprises polyamide or polyester.

37. A textile article according to claim 32, wherein:
each of said panels comprises a mixture of polyamide and elasthane.

38. A textile article according to claim 32, wherein:
the textile article is a garment adapted to be worn in direct contact with a wearer's skin.

39. A textile article according to claim 32, wherein:
the textile article is a tee-shirt adapted to be worn in direct contact with a wearer's skin.

40. A textile article according to claim 32, wherein:
the textile article is a garment adapted to be worn in direct contact with a wearer's skin, said garment comprising a member selected from the group consisting of a tee-shirt, tights, and pants.

41. A method of assembling two laminated panels, said method comprising:
creating a laminate of at least two panels, said two laminated panels comprising at least one layer of fabric material and one water-resistant protective layer fixed to the fabric material;
joining the two panels along a predetermined joining line;
flattening said two laminated panels;
pre-positioning, by gluing, a sealing strip provided with an adhesive on the joining line;
subjecting the joining line to a temperature greater than a melting temperature of the adhesive, under a predetermined pressure, for a predetermined duration, so that at least a portion of the adhesive creeps between interstices of fibers of the fabric material;
subjecting the joining line, at the end of said duration, to an accelerated cooling by cold pressing, so as to congeal the adhesive.

42. A textile article comprising:
at least two laminated panels, each of said laminated panels comprising at least one layer of fabric material and at least one water-resistant protective layer fixed on the fabric material;
said two panels being assembled along a predetermined joining line;
said joining line being covered with a sealing strip provided with a thermofusible adhesive, said adhesive having, at least partially, crept into interstices between fibers of the fabric material.

43. A textile article according to claim 42, wherein:
said two panels are assembled together by welding at said joining line.

44. A textile article according to claim 42, wherein:
said two panels are assembled together by stitching.

45. A textile article according to claim 42, wherein:
no excess material extends beyond said joining line prior to said joining line being covered with said sealing strip.

46. A textile article according to claim 42, wherein:
said thermofusible adhesive comprises a first layer of thermofusible polymer impregnating interstices between fibers of said fabric material in an outer layer of said joining line, a second layer of thermofusible polymer having mechanical strength characteristics.

47. A textile article according to claim 46, wherein:
said second layer of thermofusible polymer has characteristics of tensile strength and resistance to washing and hydrolysis.

48. A textile article according to claim 46, wherein:
said second layer of polymer is made of PU.

49. A textile article according to claim 42, wherein:
said sealing strip also comprises a layer of fabric material.

50. A textile article according to claim 49, wherein:
said layer of fabric material constitutes at least an outer surface of each one of said laminated panels.

51. A textile article according to claim 42, wherein:
said sealing strip is applied to outer surfaces of said two laminated panels.

52. A textile article according to claim 42, wherein:
said sealing strip is applied to inner surfaces of said laminated panels.

53. A textile article according to claim 49, wherein:
said sealing strip comprises a coating layer or membrane between said adhesive and said layer of fabric material.
